(19) United States
(12) Patent Application Publication
(10) Pub. No.: US 2020/0401970 A1
(43) Pub. Date: Dec. 24, 2020

(54) Dynamic Reassignment of Workers

(71) Applicant: MavenWork, Inc., San Francisco, CA (US)

(72) Inventors: Cong Xu, San Francisco, CA (US); Yi Zheng, Palo Alto, CA (US); Evan Alan Meyer, San Francisco, CA (US)

(73) Assignee: MavenWork, Inc., San Francisco, CA (US)

(21) Appl. No.: 16/446,595

(22) Filed: Jun. 19, 2019

(51) Int. Cl. G06Q 10/06

(52) U.S. Cl. CPC G06Q 10/06316; G06Q 10/063114

(57) ABSTRACT

Based at least in part on current demand and current roles of workers associated with an organization, the electronic device computes a need for a first set of workers capable of performing a type of task. Then, based at least in part on locations of a second set of workers, current roles of the second set of workers, and additional qualifications of the second set of workers, the electronic device determines dynamic reassignments to the type of task for the second set of workers. Note that the type of task is different from sets of tasks that define the current roles. Next, the electronic device provides assignment information that proposes the dynamic reassignment to the type of task for the second set of workers, and receives opt-in messages from at least a subset of the second set of workers confirming acceptance of the dynamic reassignment.

### BACKGROUND

### Field

The described embodiments relate to techniques for dynamically reassigning workers associated with an organization, who have appropriate skills, based at least in part on dynamic demand of the organization.

### Related Art

The increased availability and capabilities of portable electronic devices (such as cellular telephones) and the performance of networks (such as the Internet) continue to dramatically change people's lives. Notably, in recent years, these technologies have enabled companies to use contractors in temporary, flexibly jobs (which is sometimes referred to as the ‘gig economy’). For example, some e-commerce companies offer food delivery services via an online marketplace. Moreover, instead of employing dedicated food delivery employees, these e-commerce companies bring together restaurants and the other business, third-party delivery contractors and customers via Web-based technology to provide food delivery. In principle, these food delivery services: allow the restaurants and the other business to reach a broader market at lower costs; allow the third-party delivery contractors to earn additional income and while controlling their work schedules; and offer customers more choices and delivery flexibility.

In practice, it is usually difficult to achieve these objectives. Focusing on the labor difficulties, there is a finite pool of third-party delivery contractors and the e-commerce companies are often forced to compete for them, which increases the costs of the e-commerce companies. These challenges are compounded by the surge in demand at predictable times of day (such as dinner time). Notably, because of the limited number of third-party delivery contractors, it is usually difficult for the e-commerce companies to have sufficient resources to adequately respond, which can result in extended delivery times and increased customer frustration.

Moreover, from the perspective of the third-party delivery contractors, these temporary employment opportunities inherently constrain compensation and opportunities for advancement. In addition, by their very nature, temporary employment positions are often insecure and typically do not provide benefits. Consequently, only a small minority of workers are willing to take positions as third-party delivery contractors, which further constrains the available labor pool for the e-commerce companies.

### SUMMARY

A described embodiment relates to an electronic device that determines dynamic reassignments. This electronic device may include: a network node; an interface circuit that communicates with one or more second electronic devices; memory that stores program instructions; and a processor that executes the program instructions. During operation, the electronic device may receive demand information that specifies current demand in an organization. Then, the electronic device may access current roles of workers associated with the organization. Based at least in part on the current demand and the current roles, the electronic device may compute a need for a first set of workers associated with the organization capable of performing a type of task. Moreover, the electronic device may access predefined capabilities and additional qualifications of the workers associated with the organization, where, for a given worker associated with the organization, the predefined capabilities may include a set of tasks that define a current role of the given worker, and where the additional qualifications correspond to one or more different types of tasks than the set of tasks. Next, the electronic device may determine dynamic reassignments to the type of task for a second set of workers associated with the organization based at least in part on locations of the second set of workers, the current roles of the second set of workers, and the additional qualifications of the second set of workers, where the type of task is different from sets of tasks that define the current roles of the second set of workers. Furthermore, the electronic device may provide one or more packets or frames to the one or more second electronic devices associated with the second set of workers, where the one or more packets or frames include assignment information that proposes the dynamic reassignment to the type of task for the second set of workers. Additionally, the electronic device may receive one or more opt-in messages associated with at least a subset of the second electronic devices confirming acceptance of the dynamic reassignment.

When a number of workers in at least a subset of the second set of workers corresponding to at least the subset of the second electronic devices is less than a number of workers in the first set of workers, the electronic device may dynamically repeat the determining, providing and receiving operations for one or more instances of the second set of workers until a number of opt-in messages for the number of workers in the first set of workers are received.

Moreover, the electronic device may add additional compensation to base compensations of at least the subset of the second set of workers, where the base compensations are associated with the sets of tasks that define the current roles of at least the subset second set of workers. For example, the additional compensation may include bonuses for at least the subset second set of workers.

Furthermore, the demand information may correspond to activity of mobile stores that fulfill orders to fabricate prepared beverage products. In some embodiments, the electronic device may: receive activity information specifying activity of the mobile stores; and determine the demand information based at least in part on the activity information.

Additionally, the electronic device may provide an instruction to at least one of the one or more second electronic devices to cease operation of a mobile store or to swap out a worker associated with the mobile store based at least in part on the one or more opt-in messages.

Note that the type of task may be associated with a location that is different from the locations of the second set of workers.

Moreover, in some embodiments the dynamic reassignments may be determined based at least in part on: a time of day, a day of a week, traffic conditions, and/or a weather condition.

Furthermore, the workers may be contractors of the organization. Alternatively or additionally, the workers may be employees of the organization, where the current roles may include jobs of the employees.

Additionally, the additional qualifications may be pre-certified by the organization, a labor board or a governmental entity.

Another embodiment provides a computer-readable storage medium for use with the electronic device. This computer-readable storage medium may include program instructions that, when executed by the electronic device, causes the electronic device to perform at least some of the aforementioned operations.

Another embodiment provides a method. This method includes at least some of the operations performed by the electronic device.

Another embodiment provides a mobile store.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example of a method for determining dynamic reassignments in the system in FIG. 1 in accordance with an embodiment of the present disclosure.

FIG. 3 is a drawing illustrating an example of interactions among the electronic devices in FIG. 1 in accordance with an embodiment of the present disclosure.

FIG. 4 is a drawing of an example of dynamic reassignments in the system in FIG. 1 in accordance with an embodiment of the present disclosure.

FIG. 5 is a drawing of an example of dynamic reassignments in the system in FIG. 1 in accordance with an embodiment of the present disclosure.

FIG. 6 is a block diagram illustrating an example of an electronic device in the system of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device the dynamically adapts a workforce is described. Based at least in part on current demand and current roles of workers associated with an organization, the electronic device computes a need for a first set of workers capable of performing a type of task. Then, based at least in part on locations of a second set of workers, current roles of the second set of workers, and additional qualifications of the second set of workers, the electronic device determines dynamic reassignments to the type of task for the second set of workers. Note that the type of task is different from sets of tasks that define the current roles of the second set of workers. Next, the electronic device provides assignment information that proposes the dynamic reassignment to the type of task for the second set of workers, and receives opt-in messages from at least a subset of the second set of workers confirming acceptance of the dynamic reassignment.

When a number of workers in at least the subset of the second set of workers is less than a number of workers in the first set of workers, the electronic device may dynamically repeat the determining, providing and receiving operations for one or more instances of the second set of workers until a number of opt-in messages for the number of workers in the first set of workers are received. Moreover, the electronic device may add additional compensation (such as bonuses) to base compensations of at least the subset of the second set of workers, where the base compensations are associated with the sets of tasks that define the current roles of at least the subset second set of workers.

By dynamically determining the reassignments, allowing workers to selectively opt-in, and/or providing the additional compensation, this management technique may allow the organization to flexibly adapt its workforce to meet dynamic needs (such as the demand) while respecting the wishes of their workers and complying with work-place regulations (such as laws concerning employee compensation and job functions). Moreover, the management technique may allow the organization to voluntarily redeploy targeted workers (such as the second set of workers) having necessary skills, such as the additional qualifications and, more generally, workers who are more experienced or familiar with the type of task) based at least in part on marketplace conditions to provide improved customer service with reduced expense. Furthermore, the management technique may provide incentives to the workers, both to accept the proposed reassignments, and to obtain advanced training for the type of task, so that they are qualified or pre-certified by the organization for such a dynamic reassignment when needed. Note that is some embodiments the workers may be pre-certified by a labor board or a governmental entity for the additional qualifications and/or the type of task. For example, the labor board or the governmental entity may pre-certify workers for food handling or as cooks. Consequently, the management technique may improve the customer experience, may increase customer loyalty, and may improve satisfaction and retention of workers. Furthermore, the management technique may allow the organization to use a small group of workers to cover a larger variety of tasks, jobs or functions without incurring a large amount of overtime for some workers, but not for others. For example, a worker could perform different types of tasks at different times, and the reassignments can occur in real-time due to changing demand or can be pre-planned.

In some embodiments, the management technique is used in conjunction with a system that fulfills prepared-beverage orders (such as coffee and/or tea) using mobile stores. However, more generally, the management technique may be used by a wide variety of organizations, include non-profit companies, for-profit companies, governmental agencies, etc.

In the discussion that follows, a ‘prepared beverage product’ may be a beverage product that is ordered by a customer and that is, at least in part, prepared or fabricated by or in a mobile store or a mobile retail establishment based at least in in part on the customer's order. Thus, a ‘prepared beverage product’ may, at least in part, be made to order for the customer, as opposed to a canned beverage product (such as bottled coffee) that is prefabricated at a factory. Moreover, in the discussion that follows a ‘mobile store’ may be a type of vehicle (such as a truck) that, at least in part, fabricates or is used to fabricate prepared beverage products using equipment in the mobile store (such as using a beverage preparation device). Furthermore, in the discussion that follows, a ‘mobile hub’ may be a type vehicle (such as a truck) that conveys or brings inventory to the mobile stores and/or that may pre-prepare or that is used to pre-prepare at least a portion of a prepared beverage product for the mobile stores. (Separately or additionally, in some embodiments, a ‘mobile hub’ may bring replacement or supplemental workers to one or more of the mobile stores.) Alternatively, in the discussion that follows, a ‘fabrication hub’ may be a fixed facility (such as a warehouse and/or a factory) that stores inventory for a mobile hub or a mobile store, and/or that pre-prepares or that is used to pre-prepare at least a portion of a prepared beverage product for the mobile stores. Note that in the discussion that follows a ‘worker’ may be a full-time employee, a part-time employee, a temporary worker or a contractor.

Moreover, in the discussion that follows, electronic devices or components in a system may communicate packets or frames in accordance with a wireless communication protocol, such as: a wireless communication protocol that is compatible with an IEEE 802.11 standard (which is sometimes referred to as ‘Wi-Fi®,’ from the Wi-Fi Alliance of Austin, Tex.), Bluetooth® (from the Bluetooth Special Interest Group of Kirkland, Wash.), a LoRa communication protocol (from the LoRa Alliance of Fremont, Calif.) and/or another type of wireless interface (such as another wireless-local-area-network interface). Alternatively, or additionally, electronic devices or components in the system may communicate packets or frames using a wired communication protocol, such as a wired communication protocol that is compatible with an Institute of Electrical and Electronics Engineers (IEEE) 802.3 standard (which is sometimes referred to as ‘Ethernet’), e.g., an Ethernet II standard. However, a wide variety of communication protocols may be used in the electronic devices and/or the system, including wired and/or wireless communication. In the discussion that follows, Ethernet and Wi-Fi are used as illustrative examples.

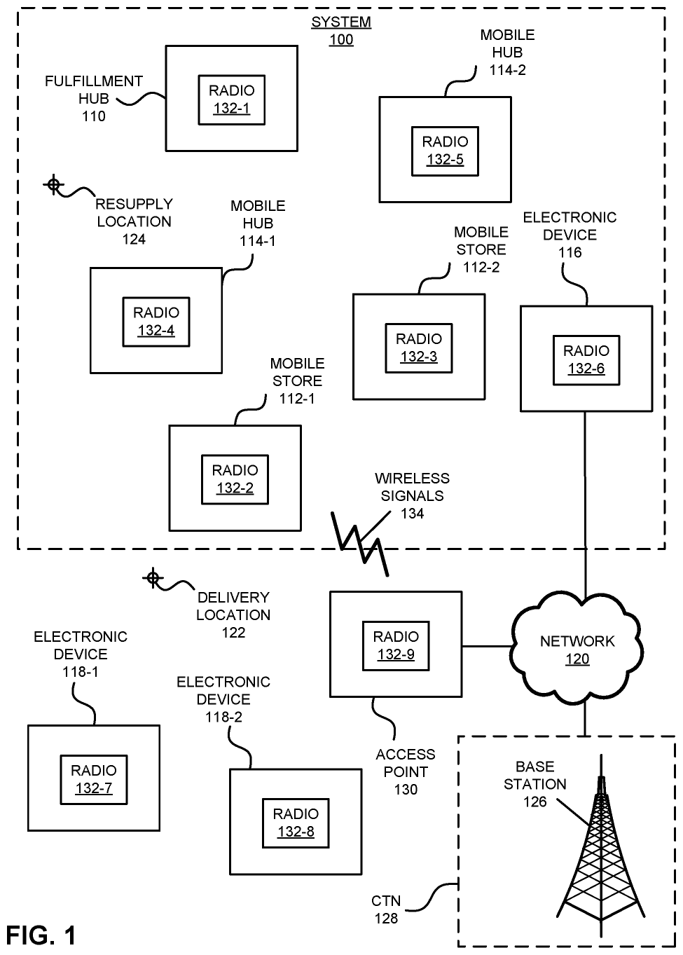

We now describe some embodiments of the management technique. FIG. 1 presents a block diagram illustrating an example of a system 100, which may include components, such as: a fulfillment hub 110, mobile stores 112 (which are sometimes referred to as ‘mobile trucks,’ ‘mobile retail establishments,’ or ‘mobile fulfillment platforms’), one or more optional mobile hubs 114, and/or an electronic device 116 (such as a computer or a server). In system 100, electronic device 116 may communicate with one or more other components in system 100 using wired and/or wireless communication. Moreover, electronic device 116 may communicate with one or more electronic devices 118 associated with customers of system 100 (such as cellular telephones, stations, another type of electronic device, etc.) using wired and/or wireless communication. For example, the wireless communication may be compatible with an IEEE 802.11 standard. Thus, the wireless communication may occur in a 2.4 GHz, a 5 GHz and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’) However, a wide variety of frequency bands may be used. Furthermore, the communication may occur via network 120 (such as the Internet, an intra-net and/or one or more dedicated links). Note that some of the components in system 100 may be at a common location, while other components (such as mobile stores 112 and/or the one or more optional mobile hubs 114) may be at other, variable locations (e.g., these components may move to different locations, such as a delivery location 122 or a resupply location 124) as a function of time. While not shown in FIG. 1, there may be additional components or electronic devices, such as a router.

Additionally, as noted previously, one or more components in system 100 and/or one or more of electronic devices 118 may communicate via wireless communication. For example, mobile store 112-1 may wirelessly communicate with a base station 126 in a cellular-telephone network (CTN) 128 and/or with an access point 130 that provides access to network 120 via an Ethernet protocol (such as a physical access point or a virtual or ‘software’ access point that is implemented on a computer or an electronic device). This wireless communication may involve: transmitting advertising frames on wireless channels, detecting one another by scanning wireless channels, exchanging subsequent data/management frames (such as association requests and responses) to establish a connection, configure security options (e.g., Internet Protocol Security), transmit and receive frames or packets via the connection (which may include the association requests and/or additional information as payloads), etc.

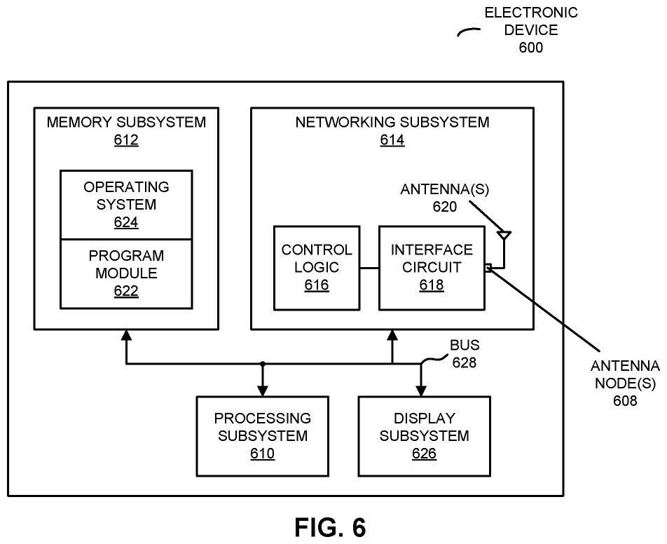

As described further below with reference to FIG. 6, fulfillment hub 110, mobile stores 112, the one or more optional mobile hubs 114, electronic device 116, electronic devices 118, base station 126 and/or access point 130 may include subsystems, such as a networking subsystem, a memory subsystem and a processor subsystem. In addition, fulfillment hub 110, mobile stores 112, one or more optional mobile hubs 114, electronic device 116, electronic devices 118, base station 126 and/or access point 130 may include radios 132 in the networking subsystems. More generally, fulfillment hub 110, mobile stores 112, the one or more optional mobile hubs 114, electronic device 116, electronic devices 118, base station 126 and/or access point 130 can include (or can be included within) any electronic devices with the networking subsystems that enable these components to communicate with each other using wired and/or wireless communication.

As can be seen in FIG. 1, wireless signals 134 (represented by a jagged line) may be transmitted from a radio 132-2 in mobile store 112-1. These wireless signals are received by radio in at least one of base station 126 and/or access point 130 (such as radio 132-9). In particular, radio 132-2 may transmit frames or packets. In turn, these frames or packets may be received by, e.g., access point 130. This may allow mobile store 112-1 to communicate information with electronic device 116. In the described embodiments, processing a frame or a packet by radios 132 may include: receiving wireless signals 134 with the frame or packet; decoding/extracting the frame or packet from the received wireless signals 134 to acquire the frame or packet; and processing the frame or packet to determine information contained in the frame or packet. Note that the communication between radio 132-2 and electronic device 116 or access point 130 may be characterized by a variety of performance metrics, such as: a data rate, a data rate for successful communication (which is sometimes referred to as a ‘throughput’), an error rate (such as a retry or resend rate), a mean-square error of equalized signals relative to an equalization target, intersymbol interference, multipath interference, an SNR, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 132 are shown in FIG. 1, one or more of these instances may be different from the other instances of radios 132.

System 100 may be used to fulfill prepared-beverage orders. Notably, fulfillment hub 110 may store inventory for a set of prepared beverage products (such as coffee, teas, juice, a fresh fruit drink prepared from fruit, a fruit drink prepared from concentrate or pre-prepared contents, a perishable drink, etc.), and may provide to mobile stores 112 portions of the inventory from fulfillment hub 110 when mobile stores 112 return to a location of fulfillment hub 110 for resupply. Alternatively, or additionally, in some embodiments the one or more optional mobile hubs 114 may be used as intermediaries to provide portions of the inventory from fulfillment hub 110 to mobile stores 112 when mobile stores 112 are at locations of the one or more optional mobile hubs 114 (such as resupply location 124).

Note that fulfillment hub 110 and/or the one or more optional mobile hubs 114 may fabricate one or more pre-prepared portions of one or more prepared beverage products in the set of prepared beverage products. A pre-pre-prepared portion of a prepared beverage product may include a liquid corresponding to the prepared beverage product. For example, a prepared beverage product may include a type of tea, and a pre-prepared portion of the prepared beverage product may be a pre-steeped liquid and may have a tea-extract concentration that exceeds a tea-extract concentration of the final prepared beverage product. Alternatively, or additionally, the prepared beverage product may include a type of coffee, and the pre-prepared portion of the prepared beverage product may be a pre-brewed liquid and may have a coffee-extract concentration that exceeds a coffee-extract concentration of the final prepared beverage product. In some embodiments, the pre-prepared portion of the prepared beverage product includes pre-cooked tapioca pearls or a chemical that reduces perceived bitterness (such as sugar, milk, almond milk, soy milk or cream).

Subsequently, a customer may use one of electronic devices 118 (such as electronic device 118-1) to provide an order for one or more prepared beverage products to system 100. For example, during the ordering process, the customer may provide order information (such as a delivery location, e.g., delivery location 122, a delivery time or time interval, payment information, information that specifies the one or more prepared beverage products, etc.) that specifies the order by interacting with a Web page provided, via network 120, by electronic device 116. Alternatively, during the ordering process, the customer may use an application or app that is pre-installed on electronic device 118-1 to provide the order information. In some embodiments, the application or system 100 may provide a recommendation or a suggestion to the customer during the ordering process, such as a suggestion about a beverage or a product based at least in part on: the customer's: previous order history, an estimated delivery time (e.g., customers may prefer black tea immediately after lunch, but may prefer green tea in mid or late afternoon), and/or geographic location (e.g., Matcha tea may be popular around northern San Francisco, but black tea may be more popular around Burbank).

Then, electronic device 116 may receive the order information. In response, electronic device 116 may provide an instruction to at least one of mobile stores 112 (such as mobile store 112-1) to fulfill at least a subset of the order from the customer at the delivery location. For example, at least the subset of the order may include at least one prepared beverage product. Note that the instruction may include information specifying at least the subset of the order (such as the prepared beverage product), the delivery location, the delivery time or time interval, customization information (such as a topping for the prepared beverage product, an ingredient to avoid using in the prepared beverage product, e.g., milk or cream if the customer is lactose intolerant, customized artwork or a message to include on a delivery container, which is sometimes referred to as a ‘container,’ that will convey the prepared beverage product when it is delivered to the customer, etc.). In some embodiments, the customization information is selected or determined (such as using a neural network or a predictive model trained using a machine-learning technique) based at least in part on information associated with one or more previous orders for the prepared beverage product and/or another prepared beverage product by the customer, which were previously received by system 100.

In response to receiving the instruction, mobile store 112-1 may fabricate and deliver at least a subset of one or more prepared beverage products specified in at least the subset of the order to the delivery location. (Note that certain beverage products may need to be fabricated within a predefined time interval before delivery in order to ensure the quality. Therefore, the production planning of these prepared beverages may include or take the scheduled delivery time into consideration.) When fabricating the prepared beverage product, mobile store 112-1 may fabricate a remainder of the prepared beverage product using the pre-prepared portion of the prepared beverage product. For example, a beverage preparation device (such as a tea or coffee machine, an espresso machine, barista equipment, etc.) in mobile store 112-1 may fabricate the prepared beverage product by adding an amount of liquid (which may have a temperature that is higher than room temperature) to the pre-prepared portion of the prepared beverage product in order to obtain a desired concentration of the prepared beverage product and/or adding a topping to the prepared beverage product. Note that the amount of liquid may be: water, milk, another non-milk alternative (such as almond milk), another liquid, etc. Alternatively, or additionally, a printing device in mobile store 112-1 may fabricate the prepared beverage product by adding or printing the customized art work to a container (such as a cup, an empty container, or a container with at least partial pre-printed art work), and then the beverage preparation device may include or pour the prepared beverage product into the customized container.

Note that the use of the pre-prepared portion of the prepared beverage product may improve the efficiency of fabrication of the prepared beverage product, e.g., by reducing a fabrication time, which may reduce the cost of fabricating the prepared beverage product and may decrease a time between the order information being received and the delivery of the prepared beverage product. Moreover, the improved efficiency may allow mobile stores 112 to service or fulfill more customers per hour (by reducing, e.g., the workload of mobile stores 112 when fulfilling a particular order), which may reduce the amortized costs per delivery and may increase the profitability of the prepared-beverage delivery service. Furthermore, the ability to customize the container may personalize the customer experience. Individually or in combination with each other, these capabilities provided by system 100 may enhance the customer experience and may increase customer loyalty.

While the preceding discussion illustrated system 100 with prepared beverage products, in other embodiments system 100 may be used to provide prepared foods (such as a macaroon), packaged goods or other products (such as novelty items), either separately or in conjunction with the prepared beverage products. Alternatively, or additionally, in some embodiments system 100 is used to provide products that customers need quickly or in a short time interval (such as within 30 min), such as pain killers (e.g., aspirin, Tylenol, naproxen, etc.) or condoms.

Furthermore, in some embodiments some or all of the operations performed by one or more components in system 100 (such as by fulfillment hub 110 or mobile stores 112) are highly or completely automated. For example, mobile stores 112 may fabricate the prepared beverage products with limited human assistance or without human assistance using automated beverage preparation devices. These beverage preparation devices may automatically load individual cartridges with the pre-prepared portions of the prepared beverage products and may automatically add other ingredients (e.g., milk, cream, almond milk, soy milk, etc.) to fabricate the prepared beverage products. Alternatively, or additionally, the beverage preparation devices may automatically transfer predefined amounts of pre-prepared portions of the prepared beverage products from storage containers and may automatically add other ingredients to fabricate the prepared beverage products. In some embodiments, mobile stores 112 may have partial or full autonomous driving or self-driving capability, which may allow mobile stores 112 to drive to the location of fulfillment hub 110, the one or more optional mobile hubs 114 and/or the delivery locations. Additionally, at the delivery locations, robots or smaller autonomous vehicles or drones may be used to bring the prepared beverage products to the customers.

However, in some embodiments, at least a portion of the fulfillment process or operations in system 100 are performed by or at least partially implemented by humans, such as workers, e.g., employees of or contractors associated with a prepared-beverage delivery service that is offered by an operator of system 100. For example, one or more electronic devices in system 100 (such as electronic device 116) may execute software that determines portions of the inventory that are loaded onto mobile stores 112, current assigned geographic operating regions for mobile stores 112 at different times, e.g., on different days of the week and/or at different times of the year, and/or assignments of workers in system 100. This information may be provided to workers at fulfillment hub 110 and/or in mobile stores 112 (e.g., it may be displayed on a display or printed out), who then, e.g., provide the portions of the inventory to mobile stores 112. In addition, the assigned geographic operating regions may be provided to mobile stores 112 and it may be presented to drivers or workers of these mobile stores, e.g., it may be displayed on displays (such as by mapping software or application executed on electronic devices in mobile stores 112).

Subsequently, drivers my drive mobile stores 112 within the assigned geographic operating regions. Moreover, when an order is received, an electronic device in system 100 (such as electronic device 116) may communicate associated instructions to one or more of mobile stores 112. The instructions may be presented to drivers and/or baristas in one or more mobile stores 112 (e.g., the instructions may be presented on a display), who may use beverage preparation devices in mobile stores 112 to fabricate the prepared beverage products. Furthermore, the drivers in one or more mobile stores 112 may drive the one or more mobile stores 112 to one or more the delivery locations and may exit the mobile stores when delivering the prepared beverage products.

In some embodiments, any manual operations in system 100 may be increasingly or fully automated over time, as necessary technology becomes available or cost effective for this application.

One challenge associated with operation of system 100 is that demand for prepared beverage products and/or other products provided via system 100 may vary e.g., with the time of day, the day of the week, traffic conditions, weather conditions (such temperature or precipitation), etc. (Note that ‘demand’ in the present discussion should be understood to encompass customer demand for the prepared beverage products and/or an associated demand for workers performing one or more types of tasks in an organization.) For example, mobile stores 112 may need to provide different types of beverage products at different times of day. In turn, the time-varying demand may affect the deployments of mobile stores 112 and/or the one or more optional mobile hubs 114 (such as the number of operating mobile stores 112, the assigned geographic operating regions or locations of mobile stores 112, etc.) and may result in a need for workers having different skills to perform sets of tasks at different locations in system 100.

However, even though an operating history of system 100 may be used to estimate or forecast time-varying demand (e.g., using a machine-learning technique, such as a neural network or a classifier trained using supervised learning), it may be difficult for an operator of system 100 to accurately estimate the time-varying demand and, thus, to correctly deploy mobile stores 112 and/or the one or more optional mobile hubs 114, and/or to correctly schedule workers in different roles, jobs or functions in system 100 (which each may have or include an associated set of tasks). For example, the roles may include operating a cash register, driving a mobile store, fabricating prepared beverage products, preparing inventory, etc. Moreover, even when the operator of system 100 correctly predicts demand, it may be advantageous for the operator to have the ability to flexibly adapt their workforce. For example, in principle such flexibility can allow system 100 to more efficiently use their workers to accomplish a variety of different tasks that need to be performed in system 100, e.g., during a time interval (such as a work day), which in turn may increase the profitability of system 100. In practice, these advantages can be difficult to achieve, because of worker expectations about their jobs, workers skills or qualifications, and labor laws that restrict changes to a worker's job or the predefined or contractually agreed set of tasks that define the worker's job.

In order to address these challenges and to obtain the advantages associated with a flexible or adaptable workforce, system 100 may implement the management technique. Notably, electronic device 116 may receive demand information (e.g., from fulfillment hub 110, one or more of mobile stores 112 and/or one or more of the one or more optional mobile hubs 114) that specifies current demand in an organization (such as a company that operates or provides system 100). For example, the demand information may correspond to activity of mobile stores 112 that fulfill orders to fabricate prepared beverage products. In some embodiments, electronic device 116 may: receive activity information specifying activity of mobile stores 112; and determine the demand information based at least in part on the activity information.

Then, electronic device 116 may access stored information about current roles of workers associated with the organization. Notably, a current role of a given worker may be defined by or may include or specify an associated set of tasks, and may have an associated title. For example, a ‘barista’ may prepare or fabricate the prepared beverage products in mobile stores 112. This may include tasks such as: loading inventory into a mobile store (such as mobile store 112-1) from fulfillment hub 110, organizing the inventory in mobile store 112-1, receiving an order, fabricating the ordered prepared beverage products, determining inventory needs of mobile store 112-1, etc. Note that the workers may be contractors of the organization. Alternatively or additionally, the workers may be employees of the organization, and the current roles may include jobs of the employees.

Based at least in part on the current demand and the current roles, electronic device 116 may compute a need for a first set of workers associated with the organization capable of performing a type of task. For example, electronic device 116 may determine that more workers of needed to prepare inventory at fulfillment hub 110 for restocking and use by mobile stores 112 and/or the one or more optional mobile hubs 114 later in the day. Alternatively, electronic device 116 may determine that more workers are needed in mobile stores 112 and/or the one or more optional mobile hubs 114 in particular assigned regions in order to fulfill current or expected customer orders.

Moreover, electronic device 116 may access predefined capabilities and additional qualifications of the workers associated with the organization. For a given worker associated with the organization, the predefined capabilities may include a set of tasks that define a current role of the given worker, and where the additional qualifications correspond to one or more different types of tasks than the set of tasks. For example, the organization that operates system 100 may allow workers to be trained in advance or to obtain a qualification or pre-certification by the organization, a labor board or a governmental entity for one or more types of tasks that are outside of or different from their current role or set of tasks. Thus, a barista may also be trained to work in fulfillment hub 110 preparing inventory for use by mobile stores 112 and/or the one or more optional mobile hubs 114. As described further below, such additional qualifications may enable the management technique. Consequently, the worker may be rewarded for obtaining qualifications or pre-certification by the organization, a labor board or a governmental entity for one more different types of tasks, such as by increasing the worker's base compensation (e.g., their salary) and/or by promoting the worker to a position with more responsibility in the organization.

Next, electronic device 116 may determine dynamic reassignments to the type of task for a second set of workers associated with the organization based at least in part on locations of the second set of workers, the current roles of the second set of workers, and the additional qualifications of the second set of workers, where the type of task is different from sets of tasks that define the current roles of the second set of workers. In some embodiments, the dynamic reassignments may be determined based at least in part on: a time of day, a day of a week, traffic conditions, and/or a weather condition. Notably, the time of day, the day of the week traffic conditions, and/or the weather condition may impact an estimated or predicted change in the determined demand (which may be computed using a machine-learning model, such as a neural network or a classifier or regression model that is trained using a supervised-learning technique, e.g., Lasso, a support vector machine, linear regression, non-linear regression, classification and regression tree, etc.). For example, when there is heavy traffic, more mobile stores may be needed to fulfill customer orders in a timely manner. Furthermore, in some embodiments, the dynamic reassignments are determined based at least in part on the willingness (or willingness level) of a worker to work additional hours for certain types of tasks that the worker is qualified to do or perform. Thus, the dynamic reassignments may also take into consideration input from workers about the types of jobs they are willing to perform.

For example, when the type of task is associated with a location that is different from the locations of the workers, electronic device 116 may dynamically reassign those workers (i.e., the second set of workers) who have an additional qualification for the type of task and who are proximate to or closest to a location where the type of task is performed (such as fulfillment hub 110). Moreover, electronic device 116 may select a number of workers (in the second set of workers) that is larger than a number of workers that is needed (in the first set of workers), so that, with attrition in responses (see below), sufficient workers can be obtained. Note that the second set of workers may be currently working for the organization when they are identified for dynamic reassignment (as opposed to workers who have the day off). In some embodiments, the determined second set of workers may have current roles that electronic device 116 identifies as having an excess number of workers or lower priority than the type of task.

Furthermore, radio 132-6 in electronic device 116 may provide one or more packets or frames to the one or more second electronic devices associated with the second set of workers (such as cellular telephones of the second set of workers, e.g., one or more of electronic devices 118), where the one or more packets or frames include assignment information that proposes the dynamic reassignment to the type of task for the second set of workers. For example, the assignment information may include an offer for the dynamic reassignment (such as a link) that is embedded in an email or a text, as well as information that specifies the dynamic reassignment (e.g., the type of task, a location where the type of task is to be performed, a timestamp when the type of task is to be performed, additional compensation associated with the type of task, etc.). A worker may accept the offer by clicking on or activating the link. Alternatively or additionally, the assignment information (such as an offer) for the worker may be presented or displayed in an application that executes on one of the second electronic devices (such as electronic device 118-2). The worker may accept the offer, by clicking on or activating a button, an icon or a virtual icon associated with a user interface in the application. Then, radio 132-8 in electronic device 118-2 may provide an opt-in message (such as a packet or a frame) confirming acceptance of the dynamic reassignment by the worker.

Subsequently, radio 132-6 in electronic device 116 may receive one or more opt-in messages associated with at least a subset of the second electronic devices (and, thus, at least a subset of the second set of workers) confirming acceptance of the dynamic reassignment. In order to allow the subset of the second set of workers to transition from their current roles to the type of task at an associated location (e.g., at fulfillment hub 110), electronic device 116 may dynamically modify deployments or staffing of one or more of mobile stores 112 and/or of at least one of the one or more optional mobile hubs 114. For example, radio 132-8 in electronic device 116 may provide an instruction (in a packet or a frame) to at least one of the one or more second electronic devices to cease operation of a mobile store or to swap out a worker associated with the mobile store based at least in part on the one or more opt-in messages.

Consequently, the management technique may result in a dynamic modification to the number of mobile stores 112, assigned regions of mobile stores 112, staffing of mobile stores 112, a number of the one or more optional mobile hubs 114, staffing of the one or more optional mobile hubs 114, staffing of fulfillment hub 110, and/or more generally operation of system 100 in order to enable the dynamic reassignments of the second set of workers and, thus, to meet the computed need for the first set of workers. Therefore, the management technique may result in real-world changes to system 100, the locations and tasks of workers (include the type of task that is different from the sets of tasks associated with the current roles of the second set of workers), as opposed to solely performing calculations using electronic device 116. Moreover, the management technique may provide improved performance of system 100 (such as smoother operations, more efficient or quicker delivery of orders, resupply of mobile stores 112 and/or the one or more optional mobile hubs 114, etc.), reduced operating costs of system 100, and/or improved operation or efficiency of electronic device 116. For example, by using the management technique, electronic device 116 may be able to determine a dynamic worker schedule during current operations that is capable of adapting to or meeting demand changes or ‘shocks’ using fewer compute resources (such as less memory, fewer processing cycles, less network bandwidth). Notably, electronic device 116 may be able to dynamically modify or adapt an initial workforce schedule (e.g., a number of workers, current roles of these workers, locations of the workers in system 100, a number of mobile stores 112, assigned regions of mobile stores 112, a number of the one or more optional mobile hubs 114, assigned regions of the one or more optional mobile hubs 114, etc.) as needed to address subsequent demand changes that exceed the margin or tolerance of the initial workforce schedule. This capability may allow electronic device 116 to determine the initial workforce schedule and any dynamic reassignments using fewer compute resources than other or existing approaches, which may require electronic device 116 to perform more instances or iterations of calculations, and/or locally (in memory) or remotely (via network 120) access historical information about operation of system 100 in an attempt to determine a workforce schedule that has sufficient margin in an attempt to address more extreme (and, thus, less probable) demand variation.

In some embodiments, when a number of workers in at least a subset of the second set of workers corresponding to at least the subset of the second electronic devices is less than a number of workers in the first set of workers (e.g., insufficient second workers voluntarily opted-in to the offered dynamic reassignment), electronic device 116 may dynamically repeat the determining, providing and receiving operations for one or more instances of the second set of workers until a number of opt-in messages for the number of workers in the first set of workers are received.

Moreover, electronic device 116 may add additional compensation to base compensations of at least the subset of the second set of workers, where the base compensations are associated with the sets of tasks that define the current roles of at least the subset second set of workers. For example, the additional compensation may include bonuses for at least the subset second set of workers. By adding additional compensation, as opposed to changing the base compensation, the management technique may ensure that there are incentives for the second set of workers to voluntarily accept or opt-in in response to an offer of a dynamic reassignment, and may ensure compliance with workplace regulations and laws that prohibit dynamic reductions to an employee's salary.

In these ways, the management technique may a flexible and adaptive workforce to facilitate a scalable, cost-effective and profitable prepared-beverage delivery service, which offers high-quality products and a superior overall customer experience. Notably, the management technique may allow system 100 to dynamically adapt to changes in demand, in terms of the number, locations and the types of prepared beverage products, as a function of time. This may allow system 100 to flexibly use resources (such as the workers who are current performing roles in system 100 on a given work day, as well as the inventory at fulfillment hub 110, mobile stores 112 and the one or more optional mobile hubs 114) to increase profits and/or to meet customer needs.

Although we describe system 100 as an example, in alternative embodiments, different numbers or types of electronic devices or components may be present. For example, some embodiments comprise more or fewer electronic devices or components. Therefore, in some embodiments there may be fewer or additional instances of at least some of the electronic devices or components. As another example, in another embodiment, different electronic devices may be transmitting and/or receiving frames or packets.

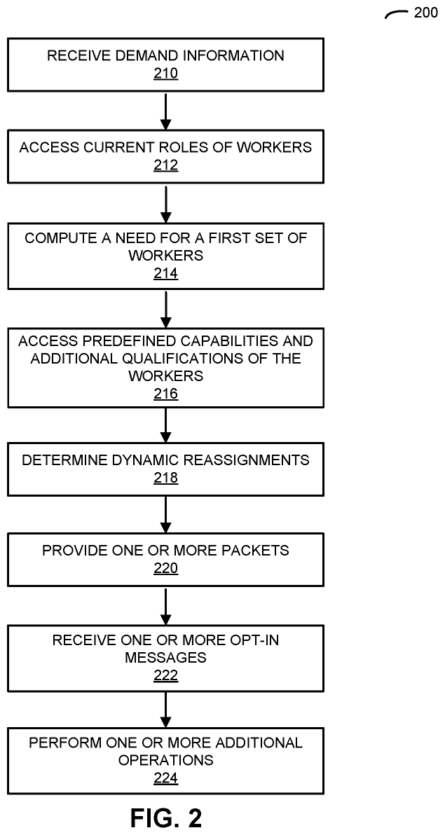

We now describe embodiments of the method. FIG. 2 presents a flow diagram illustrating an example of a method 200 for determining dynamic reassignments in a system. This method may be performed by an electronic device in a system, such as electronic device 116 in system 100 in FIG. 1.

During operation, the electronic device may receive demand information (operation 210) that specifies current demand in an organization.

Then, the electronic device may access current roles of workers (operation 212) associated with the organization. Note that the workers may be contractors of the organization. Alternatively or additionally, the workers may be employees of the organization, where the current roles may include jobs of the employees.

Based at least in part on the current demand and the current roles, the electronic device may compute a need for a first set of workers (operation 214) associated with the organization capable of performing a type of task.

Moreover, the electronic device may access predefined capabilities and additional qualifications of the workers (operation 216) associated with the organization, where, for a given worker associated with the organization, the predefined capabilities may include a set of tasks that define a current role of the given worker, and where the additional qualifications correspond to one or more different types of tasks than the set of tasks. Note that the additional qualifications may be pre-certified by the organization, a labor board or a governmental entity.

Next, the electronic device may determine dynamic reassignments (operation 218) to the type of task for a second set of workers associated with the organization based at least in part on locations of the second set of workers, the current roles of the second set of workers, and the additional qualifications of the second set of workers, where the type of task is different from sets of tasks that define the current roles of the second set of workers.

Furthermore, the electronic device may provide one or more packets or frames (operation 220) to the one or more second electronic devices associated with the second set of workers, where the one or more packets or frames include assignment information that proposes the dynamic reassignment to the type of task for the second set of workers. Additionally, the electronic device may optionally receive one or more opt-in messages (operation 222) associated with at least a subset of the second electronic devices confirming acceptance of the dynamic reassignment. For example, in some embodiments, a default condition may be for a given worker to opt in or to accept a proposed dynamic reassignment. In these embodiments, the given worker may respond to a proposed dynamic reassignment in order to decline the offer.

In some embodiments, the electronic device may optionally perform one or more additional operations (operation 224). For example, when a number of workers in at least a subset of the second set of workers corresponding to at least the subset of the second electronic devices is less than a number of workers in the first set of workers, the electronic device may dynamically repeat the determining (operation 218), providing (operation 220) and receiving (operation 222) operations for one or more instances of the second set of workers until a number of opt-in messages for the number of workers in the first set of workers are received.

Moreover, the electronic device may add additional compensation to base compensations of at least the subset of the second set of workers, where the base compensations are associated with the sets of tasks that define the current roles of at least the subset second set of workers. For example, the additional compensation may include bonuses for at least the subset second set of workers. Note that the electronic device may monitor the additional qualifications that second set of workers currently have and may accordingly adjust the bonus rate for different additional qualifications of the second set of workers. In this way, the organization can maintain a well-balanced reserve force (i.e., the second set of workers) in terms of skills needed during operations of the organization.

In some embodiments, instead of adding additional compensation, the electronic device may provide a visual incentive, such as by displaying an icon that indicates the progress of a given worker towards a goal, such as additional compensation (e.g., a bonus or a vacation day) or a promotion in the organization. In some embodiments, the additional compensation for a given worker may be based at least in part on: data input from electronic devices in one or more mobile stores, data input from electronic devices in one or more hubs, historical data of the given worker (such as hours spent on a specific task, how many times the same task is assigned to the given worker, qualification, e.g., consistency of data from quality-related sensors or monitoring in mobile stores, etc.). In general, the additional compensation may be determined based at least in part on a type of task, worker experience, worker qualifications, work quality, etc. Consequently, two individual working on the same tasks for the same number of hours during a pay period may have different rates for their additional compensation and these rates may involve over time in order to balance between production yield, worker happiness etc. Note that supervised machine learning, or reinforced machine learning may be used to train a predictive model that provides recommendations for the amount of additional compensation for the given worker, in order to align the task assignment with business goals in real time.

Furthermore, the demand information may correspond to activity of mobile stores that fulfill orders to fabricate prepared beverage products. In some embodiments, the electronic device may: receive activity information specifying activity of the mobile stores; and determine the demand information based at least in part on the activity information.

Additionally, the electronic device may provide an instruction to at least one of the one or more second electronic devices to cease operation of a mobile store or an optional mobile hub, or to swap out a worker associated with the mobile store or the optional mobile hub based at least in part on the one or more opt-in messages. Alternatively or additionally, the electronic device may provide an instruction to at least a fulfillment hub to transfer a worker to a mobile store or an optional mobile hub.

Note that the type of task may be associated with a location that is different from the locations of the second set of workers.

In some embodiments, the dynamic reassignments may be determined based at least in part on: a time of day, a day of a week, and/or a weather condition.

By determining the dynamically reassigns, the electronic device may dynamically balance, in real time, the available workers for the type of task with the current demand. Therefore, during a time with high demand, more workers producing prepared beverage products may be needed, while at times with relatively low demand, more workers maintaining or upgrading infrastructure may be needed. Method 200 may allow the electronic device to address these variations in demand, especially with the variation is unexpected or a surprise and, thus, constitutes a demand shock or surprise for the organization.

In some embodiments of method 200, there may be additional or fewer operations. Moreover, the order of the operations may be changed, and/or two or more operations may be combined into a single operation.

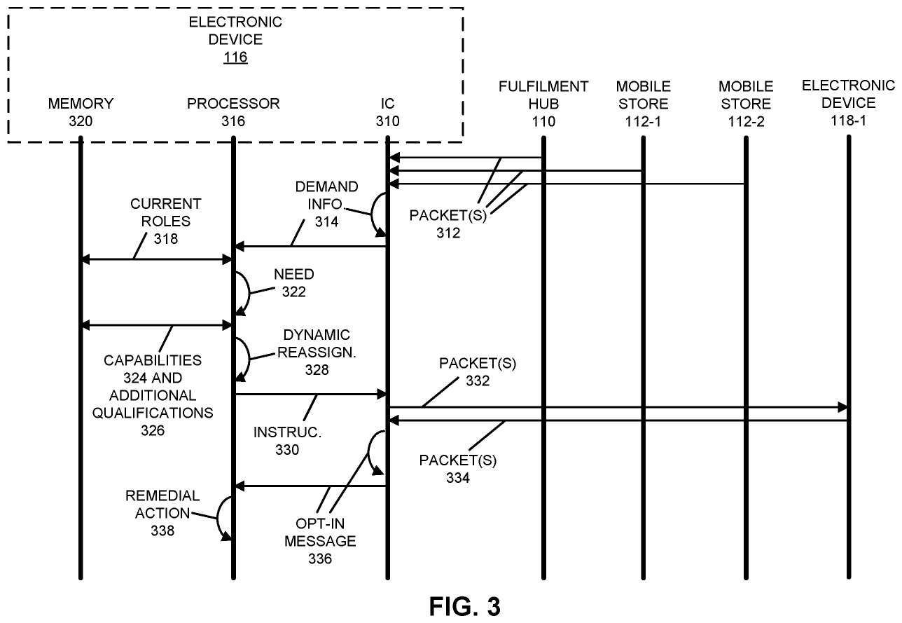

FIG. 3 presents a drawing illustrating an example of interactions among fulfilment hub 110, mobile store 112-1, mobile store 112-2, electronic device 116, and electronic device 118-1. In FIG. 3, an interface circuit 310 in electronic device 116 may receive packets 312 or frames with demand information 314 from fulfilment hub 110, mobile store 112-1 and/or mobile store 112-2, where demand information 314 specifies current demand in an organization. In response, interface circuit 310 may extract demand information 314 and provide it to processor 316 in electronic device 116.

Then, processor 316 may access current roles 318 of workers associated with the organization, e.g., from memory 320 in electronic device 116.

Based at least in part on the current demand and current roles 318, processor 316 may compute a need 322 (such as a shortage) for a first set of workers associated with the organization capable of performing a type of task.

Moreover, processor 316 may access, e.g., in memory 320, predefined capabilities 324 and additional qualifications 326 of the workers associated with the organization, where, for a given worker associated with the organization, the predefined capabilities may include a set of tasks that define a current role of the given worker, and where the additional qualifications correspond to one or more different types of tasks than the set of tasks.

Next, processor 316 may determine dynamic reassignments 328 to the type of task for a second set of workers associated with the organization based at least in part on locations of the second set of workers, current roles 318 of the second set of workers, and the additional qualifications of the second set of workers, where the type of task is different from sets of tasks that define the current roles of the second set of workers.

Furthermore, processor 316 may provide an instruction 330 to interface circuit 310 to provide assignment information that proposes dynamic reassignment 328 to the type of task for the second set of workers. In response, interface circuit 310 may provide one or more packets 332 or frames to the one or more second electronic devices (such as electronic device 118-1) associated with the second set of workers, where the one or more packets 332 or frames include the assignment information that proposes dynamic reassignment 328 to the type of task for the second set of workers. After receiving the proposed dynamic reassignment 328, a worker that uses electronic device 118-1 may selectively accept the proposed dynamic reassignment 328, e.g., by clicking or activating a link or an icon in a user interface. In response, electronic device 118-1 may provide one or more packets 334 or frames with an opt-in message 336 associated with at least a subset of the second electronic devices (such as the worker that uses electronic device 118-1) confirming acceptance of dynamic reassignment 328.

After receiving the one or more packets 334 or frames, interface circuit 310 may extract and provide opt-in message 336, interface circuit 310 may provide opt-in message 336 to processor 316. Then, processor 316 may determine if a number of workers in at least the subset of the second workers is less than a number of workers in the first set of workers, the electronic device may dynamically perform remedial action 338, such as offering dynamic reassignment 328 to additional second sets of workers, so that sufficient workers are obtained to meet need. 322. In some embodiments, remedial action 338 may include adding additional compensation to base compensations of at least the subset of the second set of workers and/or providing an instruction, e.g., to mobile store 112-1 to cease operation or to swap out a worker based at least in part on opt-in messages 336.

While FIG. 3 illustrates operations between components as unidirectional (e.g., using a line with a single arrow head on one end) or bidirectional (e.g., using a line with arrow heads at both ends), in general a given operation in FIG. 3 may be unidirectional or bidirectional.

In some embodiments, the management technique enables dynamic supply-chain tasks and associated dynamic compensation above a floor (such as bonuses in addition to a worker's base compensation). For example, on a given day, suppose that a system that fabricates and delivers prepared beverage products has 100 workers in different current roles performing sets of tasks, such as: managing inventory in a fulfillment hub, preparing at least a portion of the prepared beverage products (such as steeping tea for a concentrated precursor to a tea product that is fabricated by a mobile store), resupplying mobile stores, driving mobile stores, managing customer orders, and fulfilling customer orders. If at 4 pm the number of new orders suddenly decreases (e.g., it starts to rain), an electronic device in the system (such as a computer) may use the management technique to determine to that 25 workers (the first set of workers) need to be dynamically reassigned from the mobile stores to the fulfillment hub to brew tea and/or prepare inventory for resupplying the mobile stores (the type of task). By matching the type of task to the available skills of the workers, the electronic device may identify 35 workers (the second set of workers) who are located in mobile stores proximate to the fulfillment hub and who have the necessary additional qualification to perform the type of task.

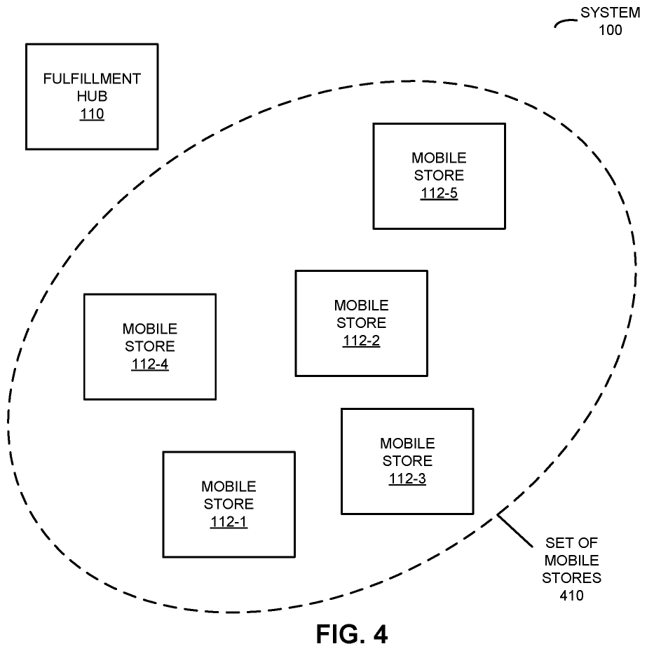

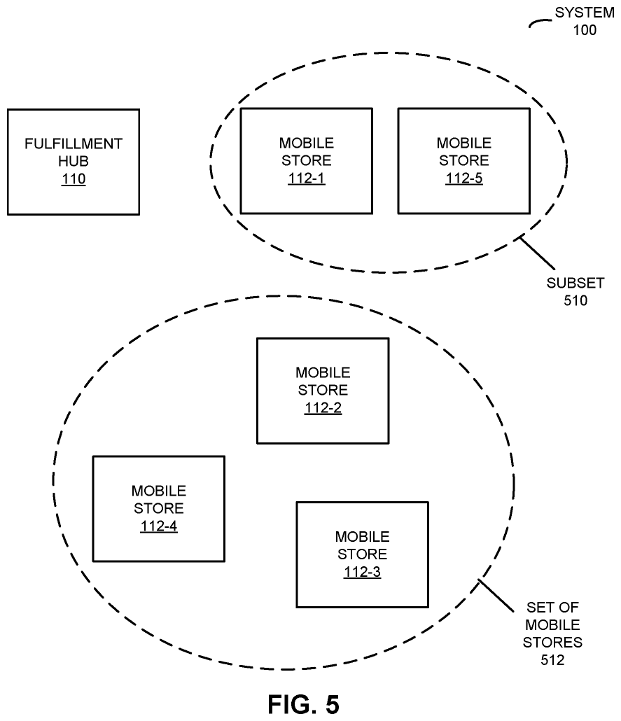

Then, the computer may offer dynamic reassignment to the identified 35 workers. 20 of these workers may accept the dynamic reassignment by providing opt-in messages. In response, the electronic device may instruct their mobile stores to return to the fulfillment hub, so that these 20 workers can transfer to the fulfillment hub to perform the type of task. For example, as shown in FIGS. 4 and 5, which presents drawings of examples of dynamic reassignments in system 100, there may initially be a set of mobile stores 410 in operation. However, based on the accepted dynamic reassignments (e.g., based on opt-in messages) a subset 510 of the mobile stores may be instructed to cease operation and to return to fulfillment hub 110, leaving a set of mobile stores 512 in operation. Thus, during dynamic reassignments, the electronic device may instruct 10 mobile stores to cease operating so that 15 workers can transfer to the fulfillment hub, may transfer five workers that opted in from five operating mobile stores to the fulfillment hub, and may consolidate the remaining five workers from the 10 mobile stores that ceased operation into the remaining five operating mobile stores. Because five more first set of workers are still needed, the electronic device may repeat one or more instances of determining of instances of a second set of workers, providing offers for dynamic reassignment and receiving opt-in messages until 25 workers (in total) accept the dynamic reassignment.

Moreover, the electronic device may provide additional compensation to the 25 workers. For example, a worker in a mobile store may earn $10/hr, while a worker in the fulfillment hub may earn $8/hr. In order to provide incentives to the second set of workers in the mobile stores, so that these workers are more likely to accept the offered dynamic reassignment, the electronic device may pay the 25 workers a bonus corresponding to an additional $2/hr, which brings their effective compensation to $12/hr. This opportunity for earning additional income may be enabled by the 25 workers previously having trained to learn the type of task, so that they are pre-certified to perform the type of task. In this way, the workers may be motivated to expand their skills, i.e., the tasks that they are capable of performing beyond the sets of tasks associated with their current roles.

In some embodiments, when determining the rates or additional compensations associated with different types of tasks, the electronic device may include or take into consideration feedback from customers. For example, the feedback may be included directly in the determination of the additional compensation for types of tasks performed by corresponding workers, or may be included indirectly, such as in the level of skill (such as the additional qualifications) such workers may need to have in order to obtain a particular amount of additional compensation.

Thus, the management technique may allow the organization or company that operates the system more flexible and efficient use of their workers. Moreover, these capabilities may allow the workers to be used without down time. Furthermore, the ability to determine dynamic reassignments that workers can voluntarily accept allows the organization to dynamically adapt a work schedule to changing conditions (such as demand, weather, a time of day, a day of the week, etc.). Furthermore, the management technique may allow the organization to obtain these capabilities with fewer workers overall, which may improve the profitability of the organization. Additionally, the electronic device that implements the management technique may do so in an automated manner.

These capabilities may allow the organization to flexibly adapt the fulfillment process and/or to dynamically shift, as needed, workers in the system based at least in part on current demand and available resources (including workers' skills) to efficiently use the available resources to provide a superior customer experience (such as prompt delivery of ordered prepared beverage products) while reducing operating costs of the system.

While the preceding discussion illustrated the communication technique by having a worker who has an additional qualification perform a type of task that is different from their current job or role (with its associated set of tasks) in the organization (i.e., the worker may selectively perform an extra type of task without changing their current role in the organization), in other embodiments the type of task may be included in the set of tasks (and thus the current role of the worker) and the dynamic reassignment may change one or more of the set of tasks that that the worker is currently performing. Thus, in some embodiments, the dynamic reassignment may vary one or more of the set of tasks that the worker performs at a given time. Moreover, instead of providing additional compensation to the worker for agreeing to perform the additional task, in embodiments where the type of task is encompassed within a more broadly defined current role and set of tasks of the worker, the compensation associated with their current job or role may be defined accordingly to reward the worker on an ongoing basis for agreeing to such a more broadly defined current role.

We now describe embodiments of an electronic device, which may perform at least some of the operations in the management technique. For example, the electronic device may include a component in system 100 (such as electronic device 116) or one of electronic devices 118. FIG. 6 presents a block diagram illustrating an electronic device 600 in accordance with some embodiments. This electronic device includes processing subsystem 610, memory subsystem 612, and networking subsystem 614. Processing subsystem 610 includes one or more devices configured to perform computational operations. For example, processing subsystem 610 can include one or more microprocessors, ASICs, microcontrollers, programmable-logic devices, graphical processor units (GPUs) and/or one or more digital signal processors (DSPs).

Memory subsystem 612 includes one or more devices for storing data and/or instructions for processing subsystem 610 and networking subsystem 614. For example, memory subsystem 612 can include dynamic random access memory (DRAM), static random access memory (SRAM), and/or other types of memory (which collectively or individually are sometimes referred to as a ‘computer-readable storage medium’). In some embodiments, instructions for processing subsystem 610 in memory subsystem 612 include: program instructions or sets of instructions (such as program instructions 622 or operating system 624), which may be executed by processing subsystem 610. Note that the one or more computer programs may constitute a computer-program mechanism. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), including: control logic 616, an interface circuit 618 and one or more antennas 620 (or antenna elements). (While FIG. 6 includes one or more antennas 620, in some embodiments electronic device 600 includes one or more nodes, such as nodes 608, e.g., a pad, which can be coupled to the one or more antennas 620. Thus, electronic device 600 may or may not include the one or more antennas 620.) For example, networking subsystem 614 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, a LoRa communication protocol, and/or another networking system.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting frames and/or scanning for frames transmitted by other electronic devices.

Within electronic device 600, processing subsystem 610, memory subsystem 612, and networking subsystem 614 are coupled together using bus 628. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc.

Electronic device 600 can be (or can be included in) any electronic device with at least one network interface. For example, electronic device 600 can be (or can be included in): a desktop computer, a laptop computer, a subnotebook/netbook, a server, a computer, a mainframe computer, a cloud-based computer, a tablet computer, a smartphone, a cellular telephone, a smartwatch, a consumer-electronic device, a portable computing device, an access point, a transceiver, a controller, a radio node, a router, a switch, communication equipment, a wireless dongle, an access point, test equipment, and/or another electronic device.

Although specific components are used to describe electronic device 600, in alternative embodiments, different components and/or subsystems may be present in electronic device 600. For example, electronic device 600 may include one or more additional processing subsystems, memory subsystems, networking subsystems, and/or display subsystems. Additionally, one or more of the subsystems may not be present in electronic device 600. Moreover, in some embodiments, electronic device 600 may include one or more additional subsystems that are not shown in FIG. 6. Also, although separate subsystems are shown in FIG. 6, in some embodiments some or all of a given subsystem or component can be integrated into one or more of the other subsystems or component(s) in electronic device 600. For example, in some embodiments program instructions 622 are included in operating system 624 and/or control logic 616 is included in interface circuit 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘means for computation’) may implement some or all of the functionality of networking subsystem 614 or electronic device 600. The integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the management technique may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the management technique may be implemented using program instructions 622, operating system 624 (such as a driver for interface circuit 618) or in firmware in interface circuit 618. Alternatively, or additionally, at least some of the operations in the management technique may be implemented in a physical layer, such as hardware in interface circuit 618.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the management technique, different numerical values may be used.

The foregoing description is intended to enable any person skilled in the art to make and use the disclosure and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a network node;
an interface circuit, coupled to the network node, configured to communicate with one or more second electronic devices;
memory configured to store program instructions;
a processor, coupled to the memory and the interface circuit, configured to execute the program instructions, wherein, when executed by the processor, the program instructions cause the electronic device to perform operations comprising:
receiving, at the network node, demand information that specifies current demand in an organization;
accessing current roles of workers associated with the organization;
computing, based at least in part on the current demand and the current roles, a need for a first set of workers associated with the organization capable of performing a type of task;
accessing predefined capabilities and additional qualifications of the workers associated with the organization, wherein, for a given worker associated with the organization, the predefined capabilities comprise a set of tasks that define a current role of the given worker, and wherein the additional qualifications correspond to one or more different types of tasks than the set of tasks;
determining dynamic reassignments to the type of task for a second set of workers associated with the organization based at least in part on locations of the second set of workers, the current roles of the second set of workers, and the additional qualifications of the second set of workers, wherein the type of task is different from sets of tasks that define the current roles of the second set of workers;
providing, to the network node, one or more packets or frames intended for the one or more second electronic devices associated with the second set of workers, wherein the one or more packets or frames comprise assignment information that proposes the dynamic reassignment to the type of task for the second set of workers; and
receiving, at the network node, one or more opt-in messages associated with at least a subset of the second electronic devices confirming acceptance of the dynamic reassignment.

2. The electronic device of claim 1, wherein the operations comprise, when a number of workers in at least a subset of the second set of workers corresponding to at least the subset of the second electronic devices is less than a number of workers in the first set of workers, dynamically repeating the determining, providing and receiving operations for one or more instances of the second set of workers until a number of opt-in messages for the number of workers in the first set of workers are received.

3. The electronic device of claim 1, wherein the operations comprise adding additional compensation to base compensations of at least the subset of the second set of workers; and
wherein the base compensations are associated with the sets of tasks that define the current roles of at least the subset second set of workers.

4. The electronic device of claim 3, wherein the additional compensation comprises bonuses for at least the subset second set of workers.

5. The electronic device of claim 1, wherein the demand information corresponds to activity of mobile stores that fulfill orders to fabricate prepared beverage products.

6. The electronic device of claim 5, wherein the operations comprise:
receiving, at the network node, activity information specifying activity of the mobile stores; and
determining the demand information based at least in part on the activity information.

7. The electronic device of claim 1, wherein the operations comprise providing, to the network node, an instruction intended for one of the one or more second electronic devices to cease operation of a mobile store or to swap out a worker associated with the mobile store based at least in part on the one or more opt-in messages.

8. The electronic device of claim 1, wherein the type of task is associated with a location that is different from the locations of the second set of workers.

9. The electronic device of claim 1, wherein the dynamic reassignments are determined based at least in part on: a time of day, a day of a week, traffic conditions, or weather conditions.

10. The electronic device of claim 1, wherein the workers comprise contractors of the organization.

11. The electronic device of claim 1, wherein the workers comprise employees of the organization; and
wherein the current roles comprise jobs of the employees.

12. The electronic device of claim 1, wherein the additional qualifications are pre-certified by the organization, a labor board or a governmental entity.

13. A non-transitory computer-readable storage medium for use in conjunction with an electronic device, the computer-readable storage medium storing program instructions that, when executed by the electronic device, causes the electronic device to perform operations, comprising:
receiving demand information that specifies current demand in an organization;
accessing current roles of workers associated with the organization;
computing, based at least in part on the current demand and the current roles, a need for a first set of workers associated with the organization capable of performing a type of task;
accessing predefined capabilities and additional qualifications of the workers associated with the organization, wherein, for a given worker associated with the organization, the predefined capabilities comprise a set of tasks that define a current role of the given worker, and wherein the additional qualifications correspond to one or more different types of tasks than the set of tasks;
determining dynamic reassignments to the type of task for a second set of workers associated with the organization based at least in part on locations of the second set of workers, the current roles of the second set of workers, and the additional qualifications of the second set of workers, wherein the type of task is different from sets of tasks that define the current roles of the second set of workers;
providing one or more packets or frames intended for one or more second electronic devices associated with the second set of workers, wherein the one or more packets or frames comprise assignment information that proposes the dynamic reassignment to the type of task for the second set of workers; and
receiving one or more opt-in messages associated with at least a subset of the second electronic devices confirming acceptance of the dynamic reassignment.

14. The non-transitory computer-readable storage medium of claim 13, wherein the operations comprise, when a number of workers in at least a subset of the second set of workers corresponding to at least the subset of the second electronic devices is less than a number of workers in the first set of workers, dynamically repeating the determining, providing and receiving operations for one or more instances of the second set of workers until a number of opt-in messages for the number of workers in the first set of workers are received.

15. The non-transitory computer-readable storage medium of claim 13, wherein the operations comprise adding additional compensation to base compensations of at least the subset of the second set of workers; and
wherein the base compensations are associated with the sets of tasks that define the current roles of at least the subset second set of workers.

16. The non-transitory computer-readable storage medium of claim 13, wherein the demand information corresponds to activity of mobile stores that fulfill orders to fabricate prepared beverage products.

17. The non-transitory computer-readable storage medium of claim 16, wherein the operations comprise:
receiving activity information specifying activity of the mobile stores; and
determining the demand information based at least in part on the activity information.

18. The non-transitory computer-readable storage medium of claim 13, wherein the operations comprise providing, to the network node, an instruction intended for one of the one or more second electronic devices to cease operation of a mobile store or to swap out a worker associated with the mobile store based at least in part on the one or more opt-in messages.

19. The non-transitory computer-readable storage medium of claim 13, wherein the dynamic reassignments are determined based at least in part on: a time of day, a day of a week, traffic conditions, or weather conditions.

20. A method for determining dynamically reassignments, comprising:
receiving demand information that specifies current demand in an organization;
accessing current roles of workers associated with the organization;
computing, based at least in part on the current demand and the current roles, a need for a first set of workers associated with the organization capable of performing a type of task;
accessing predefined capabilities and additional qualifications of the workers associated with the organization, wherein, for a given worker associated with the organization, the predefined capabilities comprise a set of tasks that define a current role of the given worker, and wherein the additional qualifications correspond to one or more different types of tasks than the set of tasks;
determining dynamic reassignments to the type of task for a second set of workers associated with the organization based at least in part on locations of the second set of workers, the current roles of the second set of workers, and the additional qualifications of the second set of workers, wherein the type of task is different from sets of tasks that define the current roles of the second set of workers;
providing one or more packets or frames intended for one or more second electronic devices associated with the second set of workers, wherein the one or more packets or frames comprise assignment information that proposes the dynamic reassignment to the type of task for the second set of workers; and
receiving one or more opt-in messages associated with at least a subset of the second electronic devices confirming acceptance of the dynamic reassignment.
